(19) United States
(12) Patent Application Publication
(10) Pub. No.: US 2014/0081799 A1
(43) Pub. Date: Mar. 20, 2014

(54) PERSONAL STOREROOMS FOR ONLINE SHOPPING

(71) Applicant: Tal LEVY, Kfar Saba (IL)

(72) Inventor: Tal LEVY, Kfar Saba (IL)

(21) Appl. No.: 13/623,120

(22) Filed: Sep. 20, 2012

(51) Int. Cl. G06Q 30/00

(52) U.S. Cl. 705/26.7; 705/27.2; 705/26.8

(57) ABSTRACT

A method, system, non-transient computer-readable storage medium and computer product for online shopping via wired or wireless server communication are provided. The method for online shopping includes creating public aisles and at least one personal storeroom for each client in an online store application at the server and enabling each client to select online products offered for sale from the created personal storerooms and public aisles. The method for online shopping includes presenting the online store to each client as an animated cartoon of a three-dimensional virtual store.

### FIELD OF THE INVENTION

The present invention relates to online shopping and, more particularly, to online shopping using personal storerooms.

### BACKGROUND OF THE INVENTION

Online shopping allows users to purchase products selected from a huge variety of products offered on the web using desktop or mobile computers, Smartphones, Tablets and the like. Online shopping allows users to read up on products and policies before ordering and to compare prices and other product characteristics.

Many shopping applications are available today such as price check that checks the prices in the stores by scanning the barcode on the product and comparing it to other online stores to make sure the user is getting the best price. Another application called Deal Watch provides all the shopping deals in one place.

However, the web offers an overwhelming amount of information when one is looking for a product, or a list of products, which often makes online shopping tedious and less appealing.

It would be highly advantageous to provide an online shopping experience that would be tailored to the user and would be less tedious and more appealing. Furthermore, it would be highly advantageous to provide an online personal store application that creates a unique personal storeroom for each user where the storerooms are updated automatically by the application and may be further customized by the users according to their preferences and needs.

### SUMMARY OF THE INVENTION

A method for online shopping via wired or wireless server communication is provided. The method includes creating public aisles and at least one personal storeroom for each client in an online store application at the server and enabling each client to select online products offered for sale from the created personal storerooms and public aisles.

According to a further feature of an embodiment of the present invention, the method further includes presenting the online store to each client as an animated cartoon of a three-dimensional virtual store.

According to a further feature of an embodiment of the present invention, the method further includes transmitting lists of purchased products to a warehouse and packing and delivering the selected products to the clients.

According to a further feature of an embodiment of the present invention, the step of enabling each client to select products from the provided personal storerooms or public aisles includes further the step of providing animated cartoon shopping carts to the users.

According to a further feature of an embodiment of the present invention, the method further includes the step of storing at the online store operator's server for each client the list of products that the client purchased from the public aisles in the client's personal storeroom at the server.

According to a further feature of an embodiment of the present invention, the method further includes the step of enabling each of the plurality of clients to customize their personal storerooms.

According to a further feature of an embodiment of the present invention, the step of presenting the online store to each client as an animated cartoon of a three-dimensional virtual store further includes mimicking the online store products corresponding to real products.

According to a further feature of an embodiment of the present invention, the step of enabling each client to select online products from the created personal storerooms and public aisles includes further the step of enabling the users to navigate between the online store aisles and to click-and-drag or touch-and-drag products from the shelves to the users shopping carts.

According to a further feature of an embodiment of the present invention, the online store application is selected from the group consisting of: Smartphone, Tablets and internet applications.

According to a further feature of an embodiment of the present invention, the online store may mimic supermarkets, grocery stores, home appliance stores and clothing stores.

According to a further feature of an embodiment of the present invention, the step of enabling each user to select products further includes the step of providing means for navigating between the online store aisles using touch screens or a computer mouse.

According to a further feature of an embodiment of the present invention, the method further includes the step of providing animated advertisement screens in the provided online store aisles.

According to a further feature of an embodiment of the present invention, the method includes further the step of providing animated store employees configured to offer products and on sale deals to the plurality of users.

According to a further feature of an embodiment of the present invention, the method includes further the step of providing lists of products of recommended recipes in the provided advertisements screens.

According to a further feature of an embodiment of the present invention, a system configured for online shopping is provided. The system includes a storage medium at a server for storing the online store computer readable code and a processor for executing the program code. The computer readable code includes program code for creating public aisles and at least one personal storeroom for each client of an online store application offering products on their shelves, providing a virtual shopping carts to each client, and enabling each client to select online via wired or wireless communication products from the provided personal storerooms and public aisles into the provided shopping carts.

According to a further feature of an embodiment of the present invention, the program code includes program code for transmitting lists of purchased products to warehouses where the products are packed and delivered to the clients.

According to a further feature of an embodiment of the present invention, the program code includes program code to be provided to a plurality of clients via wired or wireless communication, wherein the provided program code enable clients to use the online store application and to communicate with the online store server.

According to a further feature of an embodiment of the present invention, the storage medium is used to store products information to be presented on the clients' electronic devices' screens.

According to a further feature of an embodiment of the present invention, the program code at the server is configured to allow removing products that were sold out from the warehouses and for adding new products to be offered to the users.

According to a further feature of an embodiment of the present invention, a non-transient computer-readable storage medium having computer readable code embodied on the storage medium is provided. The computer-readable code includes to program code for creating at least one personal storeroom for each user of an online store application including further public aisles offering products on their shelves, and program code for enabling each user to select products from the provided personal storerooms or public aisles into their virtual shopping carts.

According to a further feature of an embodiment of the present invention, the computer readable code includes program code for transmitting the lists of selected products to warehouses where the products are packed and delivered to the users' addresses.

According to a further feature of an embodiment of the present invention, the computer readable code includes program code for presenting the online store to each, the client as an animated cartoon of a three-dimensional virtual store.

According to a further feature of an embodiment of the present invention, the computer readable code includes program code for allowing navigation between the online store aisles and selection of products from the shelves by click-and-drag or touch-and-drug the products into the users shopping carts.

According to a further feature of an embodiment of the present invention, the computer readable code includes program code for allowing each user to create a multiple number of personal shelves, and for enabling clients to re-order their selected products according to their preferences in the personal storerooms.

According to a further feature of an embodiment of the present invention, the computer readable code includes program code for selecting, individually or collectively, products from the user personal storeroom to the client shopping cart.

According to a further feature of an embodiment of the present invention, the computer readable code includes program code for removing products that were sold out from the warehouses and for adding new products to the public aisle shelves.

According to a further feature of an embodiment of the present invention, the computer readable code includes program code to be provided to a plurality of clients via wired or wireless communication, wherein the provided program code enable clients to use the online store application and to communicate with the online store server.

According to a further feature of an embodiment of the present invention, the program code provided to clients includes program code for presenting the products information on the users electronic devices' screen.

According to a further feature of an embodiment of the present invention, the program code includes program code for displaying a top view of the online store aisles and allowing convenient navigation between the online store aisles.

According to a further feature of an embodiment of the present invention, the program code includes program code for providing an options tool bar presented on the users electronic devices' screens.

According to a further feature of an embodiment of the present invention, the clients electronic devices may be: Smartphones, Tablets, desktop computers and mobile computers.

According to a further feature of an embodiment of the present invention, a computer program product for online shopping is disclosed. The computer program product includes a computer readable storage medium that includes further a first program instructions to create at least one personal storeroom for each user of an online store application including further public aisles offering products on their shelves, and second program instructions to enable each user to select products from the provided personal storerooms or public aisles into their virtual shopping carts. The computer program product program instructions are stored on the computer readable storage medium.

Additional features and advantages of the invention will become apparent from the following drawings and description.

### BRIEF DESCRIPTION OF THE DRAWINGS

Various embodiments are herein described, by way of example only, with reference to the accompanying drawings, wherein:

FIG. 1A illustrates a typical online grocery store aisle passage, according to embodiments of the present invention;

FIG. 1B illustrates a personal storeroom shelf, according to embodiments of the present invention;

FIG. 1C illustrates another user personal storeroom shelf, according to embodiments of the present invention;

FIG. 2 illustrates a typical online grocery store aisle, according to embodiments of the present invention;

FIG. 3 illustrates the shopping cart content as displayed on the user Smartphone screen, according to embodiments of the present invention;

FIG. 4 illustrates a top view map of the online grocery store, according to embodiments of the present invention;

FIG. 5 illustrates the system configured for online shopping in a block diagram, according to embodiments of the present invention;

FIG. 6A illustrates the online personal store application initialization in a flowchart diagram, according to embodiments of the present invention;

FIG. 6B illustrates the online personal store application after initialization in a flowchart diagram, according to embodiments of the present invention;

FIG. 7 illustrates the method for online shopping in a personal store in a flow chart diagram, according to embodiments of the present invention;

FIG. 8 is a continuation of FIG. 7 that further includes the steps of storing purchased products in the application memory and customizing the users personal storerooms, according to embodiments of the present invention;

FIG. 9 is a continuation of FIG. 7 that further includes providing special offers to users on special deals screens, according to embodiments of the present invention; and

FIG. 10 is a continuation of FIG. 7 that illustrates customization of the personal storeroom in a flow chart diagram, according to embodiments of the present invention.

### DESCRIPTION OF THE PREFERRED EMBODIMENTS

The principles and operation of a system configured for shopping in a online store and a method for shopping in an online store according to the present invention may be better understood with reference to the drawings and the accompanying description. As will be appreciated by one skilled in the art, aspects of the present invention may be embodied as a system, method or computer program product. The system configured for online shopping includes a storage medium for storing the online store program code, wherein the program code includes program code for (i) creating a plurality of personal storerooms for each user in a online store application comprising further public aisles offering products on their shelves, (ii) enabling each user to select products from the provided personal storerooms or public aisles into the users online shopping carts, (iii) transmitting lists of purchased products to warehouses where the products are packed and delivered to the users.

The system configured for online shopping includes further a processor for executing the program code and a user online store program code provided to multiple users to be executed by their electronic device processors and further communicating with the storage medium online store program code.

The system configured for online shopping presents the online store to clients as an animated cartoon of a three-dimensional virtual store. The online store public aisles and users' personal storerooms are visualized using three dimensional (3D) computer graphics.

According to embodiments of the present invention, the system storage medium is used to store data related to each user personal storeroom. The personal storeroom data includes the products the user purchased and hence prefers and may be customized by the user in a daily shopping shelf, a weekend shopping shelf, a shopping for dinner event shelf, etc.

Furthermore, the system storage medium is used to store the products information to be presented on the users electronic devices screens upon clicking a product.

According to embodiments of the present invention, the system storage medium memory is configured to allow removing products from the online store shelves if they were sold out and adding new products to be offered to the users.

According to embodiments of the present invention, the online store may be for example a supermarket, a grocery store, a home appliance store, a clothing store and any other store, offering any kind of product.

According to embodiments of the present invention, the provided personal storeroom provides an efficient and user friendly online shopping experience that allows the users to shop effectively where their previously selected preferred products are presented in their personal storerooms, while other products and on sale items are offered in the public aisles of the online store.

The first screen of the online store application is the online store on sale aisle. The users do not need to have a username and password to enter initially to the online store application and they will be asked to register upon payment for their shopping cart content. After registration, the user will be directed to his or her personal storeroom upon login to the online store application.

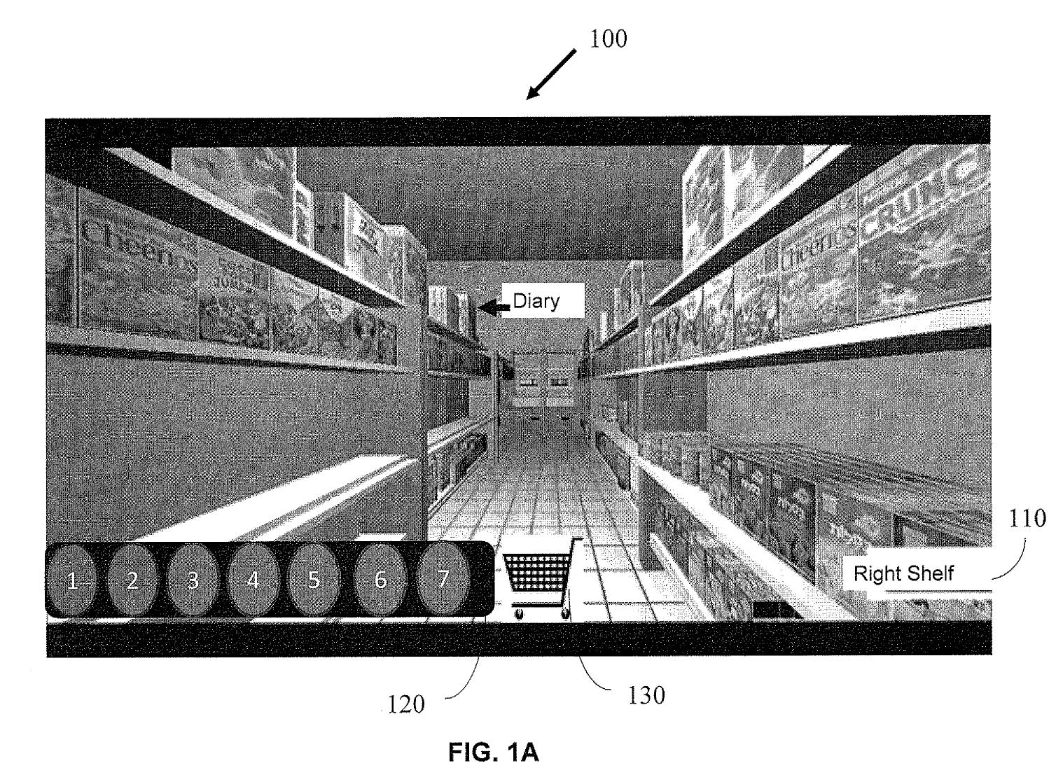

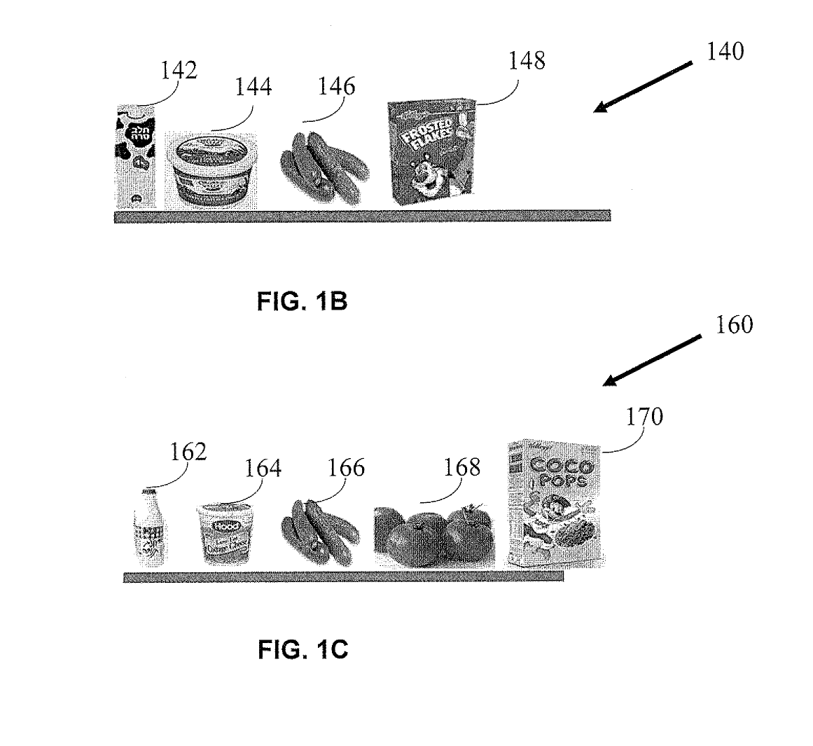

Referring now to the drawings, FIG. 1 illustrates a typical online grocery store aisle as displayed on a touch screen, according to embodiments of the present invention. The typical online store aisle 100 includes a right and left aisle offering products in this case, cereals in a supermarket. Cereals are one non limiting example of products that may be offered to users. Users may navigate forward along the aisle and may touch the right hand side button 110 to transit to a right shelf screen for example.

Touching a product on this screen or an aisle screen opens a new window with the product picture, name, company, price, sale offers, quantity requested by the user (1 by default), add to cart button, add to favorite's button and a list of recommended similar products offered to the user.

Dragging a product down using the touch screen introduces the shopping cart 130 and upon entering the shopping cart, the product is added to the user bill.

Dragging a finger to the right on the touch screen without touching a product moves the user forward along the aisle. Dragging a finger to the left on the touch screen moves the user backward along the aisle.

Touching the screen bottom introduces a floating navigation tool bar that includes typically 7 buttons. The navigation tool bar disappears upon touching the screen elsewhere. The floating navigation tool bar 120 that includes 7 buttons is provided with all applications screens. Button 1 enables transition to the left aisle shelf. Button 2 enables transition to a top view of the online store. Button 3 enables transition to the personal storeroom. Button 4 enables transition to the shopping cart content. Button 5 enables transition to a search screen. Button 6 enables transition to an option menu. Button 7 enables transition to the right aisle shelf. The user may customize his personal storeroom using button 6 that enables transition to the option menu. The online store shopping cart 130 is shown on the bottom of F1G. 1. Users may select products from the shelves by clicking-and-dragging products from the shelves to their online carts 130.

FIG. 1B illustrates a personal storeroom shelf, according to embodiments of the present invention. The personal storeroom shelf 140 includes milk carton 142, cheese can 144, cucumbers 146 and cereal 148 that the user had purchased online previously. The next time the user visits the online store she or he visits first the personal storeroom and may select products from her or his preferred products saving significant shopping time and effort. The user may, at any time, navigate easily to the online store public aisles looking for additional products and for on sale offers using touch screen buttons.

FIG. 1C illustrates another user personal storeroom shelf, according to embodiments of the present invention. The personal storeroom shelf 160 includes a different brand milk carton 162, a different brand cheese can 164, cucumbers 166, tomatoes 168 and different brand cereal 170. The user may re-order the personal storeroom products by long-touch a product and dragging it to a new location on the personal storeroom shelf. The user may further customize his storeroom according to a set of provided ordering options.

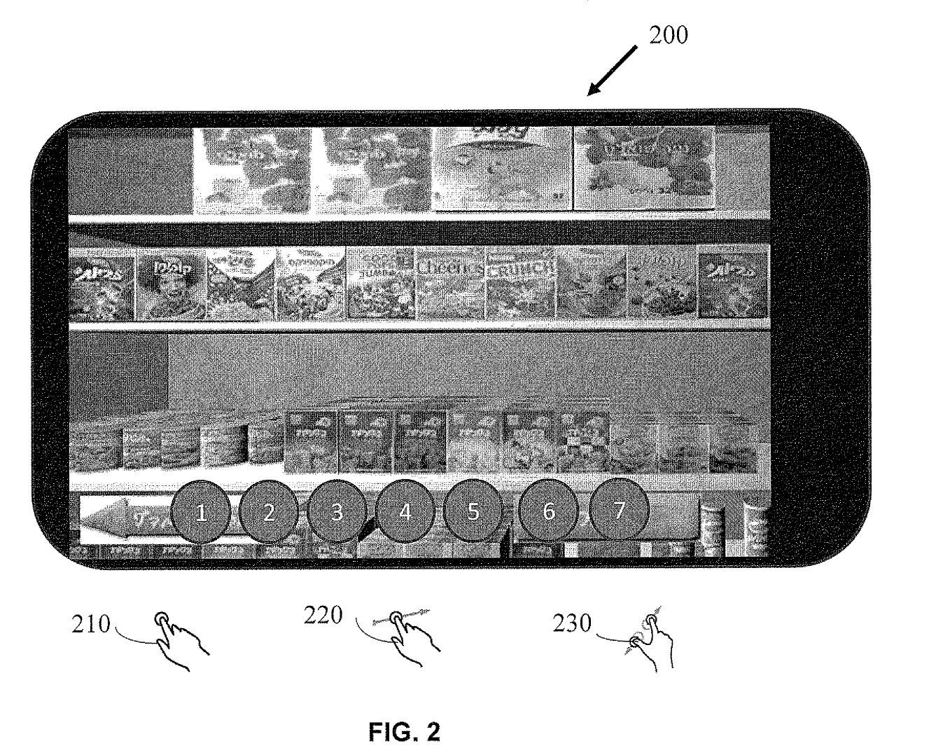

FIG. 2 illustrates a typical online grocery store aisle according to embodiments of the present invention. The online store aisle 200 includes typically 3-5 shelves, 1-3 products ordered vertically and 5-10 products horizontally in each shelf. At the bottom of the shelf the product price tags may be shown with special sale offer tags.

On the bottom of FIG. 2, below screen 200, typical touch screen operations of Smartphones applications and the like are illustrated: a push button operation 210 may be used for selecting an option or for switching to another screen, a drag operation may be used for dragging products to the shopping carts and for navigation through the online store aisles 220 and zoom-in or zoom-out operations may be used to enlarge products or navigate away from a scene.

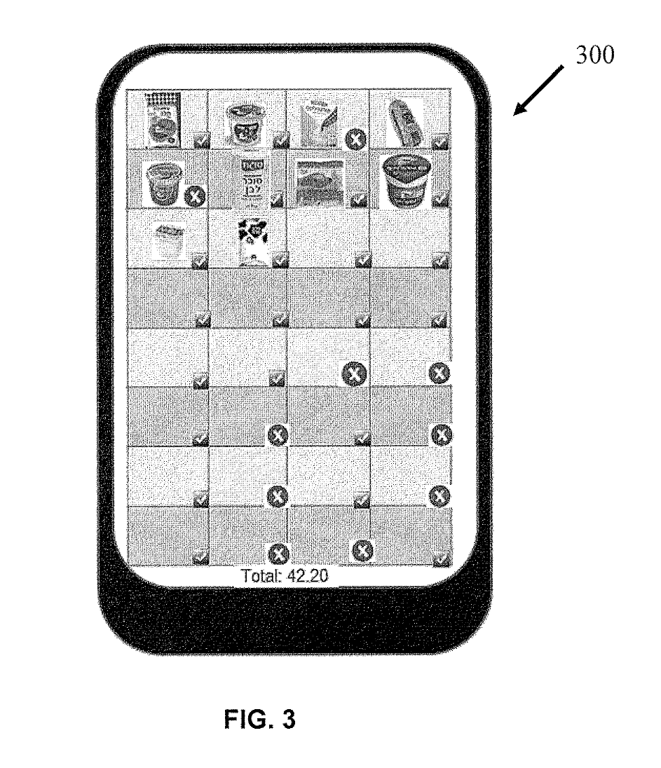

FIG. 3 illustrates shopping cart content as displayed on the user Smartphone screen, according to embodiments of the present invention. User screen 300 is divided typically to 24 cells where each selected item is shown in a cell. If the list of products includes more than 24 items, a second screen will present the additional items. Touching a product in the cart opens a window with the following options: edit the number of product items selected, bring the user back to the product's shelf. At the bottom of the window, option buttons for deleting the selected product from the cart, for adding to favorites, adding to existing lists or creating a new list of products appear.

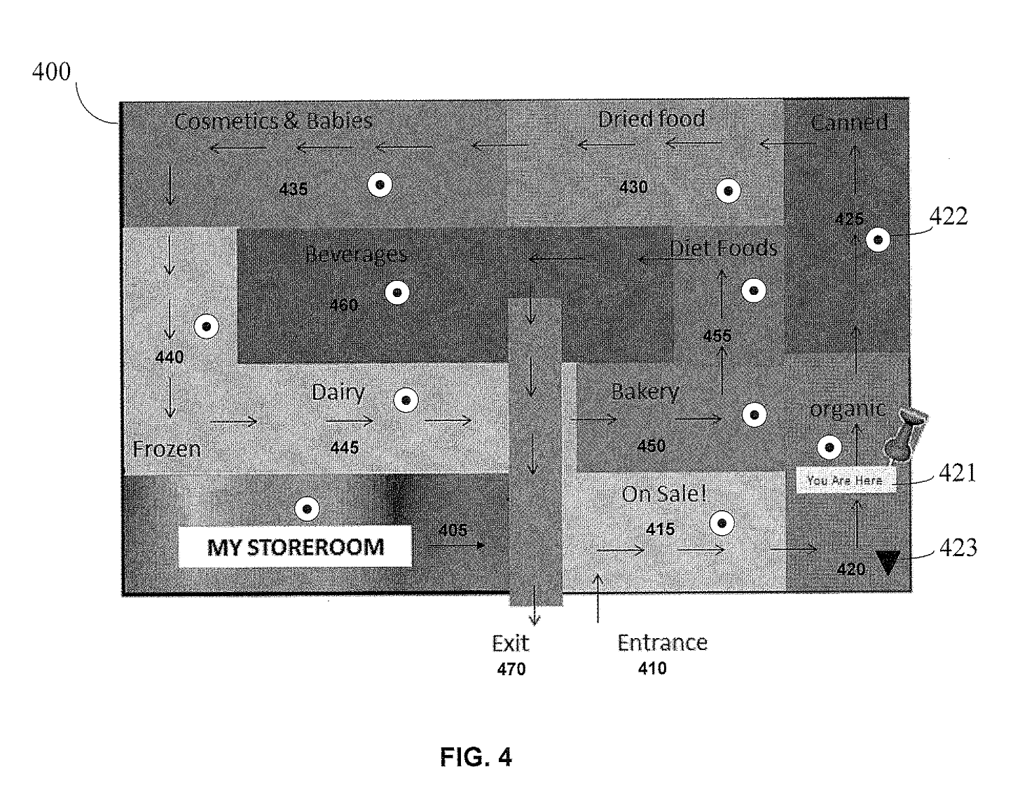

FIG. 4 illustrates a top view map 400 of the online grocery store, according to embodiments of the present invention. Via button 2 shown in FIG. 2, the users are provided with a top view map of the online store that illustrates the various departments. My storeroom 405 is shown on the left side bottom of top view map 400 and is the initial aisle upon entering the online store application after registration. The on sale aisle 415 is the initial aisle upon entering the online store application 410 for non registered users. The organic aisle 420 and the canned aisle 425 are next. A tack 421 points on the current user location from entering to exiting the online store application. The dried foods aisle 430 and the babies & cosmetics aisles 435 follow. The frozen food aisle 440, dairy aisle 445, bakery 450, diet foods 455 and beverages aisle 460 follow before existing 470 the online store. The online store top view map 400 illustrated in FIG. 4 is a non limiting example of an online store and any other aisles and the order of those aisles may be included in embodiments of the present invention and are in the scope of the present invention. The online store may have a spiral shape, a maze shape, a 3D store shape with animated staircases and elevators, and the users can navigate continuously from the store entrance to the store exit using their touch screens. The names of the aisles may be written on the top of each aisle in the top view map. The various departments may appear in different colors, such as white for dairy, green for fruits and vegetables, pink for the butchery, blue for hygiene department etc.

In each department a check point, illustrated with circle 422, is used to enter the department at the check point from the top view map of the online store.

Touching any other point in the top view map will transfer the user to the entrance of each department.

At the right side bottom of the top view map an option button is provided 423. The option button when touched opens an options window with typically 5 option buttons. The option buttons may be 1—return to the user location in the aisle just before the user selected the top view map. 2—add a check point (returns to the top view map and allows the user to add a check point in this location by a touch). 3—remove a check point (returns to the top view map and allows the user to remove a check point by touching it). 4—remove department (if the user does not want to visit a department (the organic for example) he may remove it from the top view map only or from both the top view and the navigation route). 5—add department (from the list of departments that are not shown in the top view map and are in the navigation route).

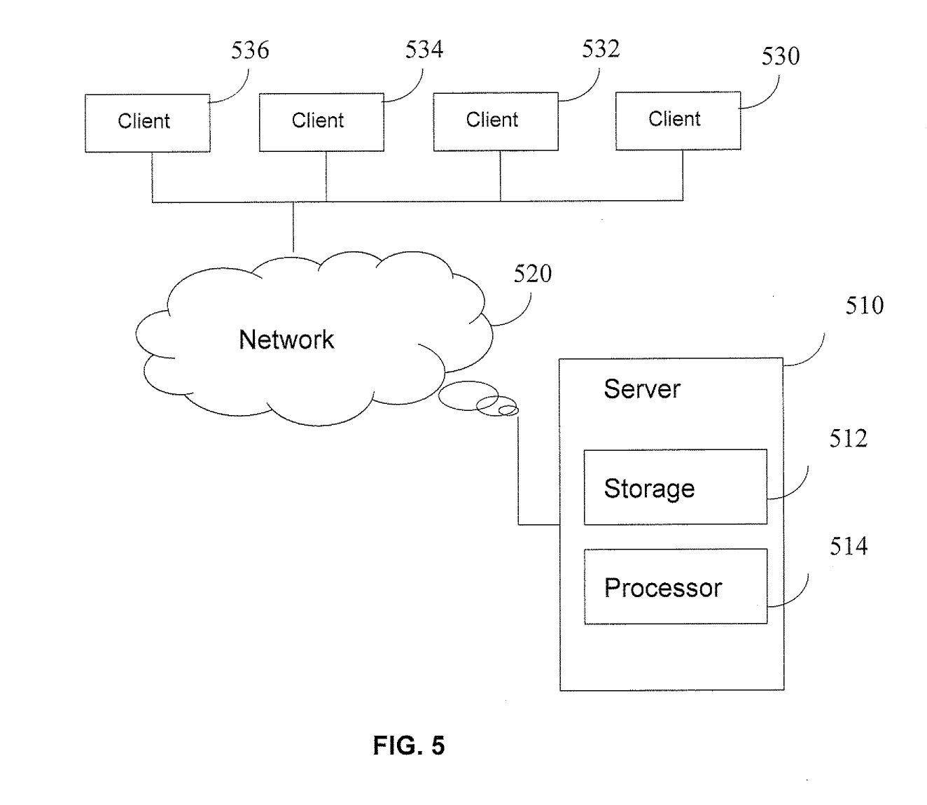

FIG. 5 illustrates the system configured for online shopping in a block diagram, according to embodiments of the present invention. The system configured for online shopping 500 includes server-client architecture. Server 510 is connected via wired and wireless cloud 520 to a plurality of clients 520, 532, 534 and 536. The system configured for online shopping 500 includes a storage medium 512 at a server 510 for storing the online store computer readable program code and a processor 514 for executing the program code. The computer readable program code includes program code for creating public aisles and at least one personal storeroom for each client of an online store application offering products on their shelves, providing a virtual shopping carts to each client and enabling each client to select online via wired or wireless communication products from the provided personal storerooms and public aisles. The computer readable program code includes program code for transmitting the lists of selected products to warehouses where the products are packed and delivered to the users' addresses.

Computer-readable program code for carrying out operations for aspects of the present invention may be written in any combination of one or more programming languages, including an object oriented languages, such as Java®, Smalltalk, C++ or the like and conventional procedural programming languages, such as the “C” programming language or the like.

Program code embodied on a computer-readable medium may be transmitted using any appropriate medium, including but not limited to wireless, wireline, optical fiber cable, RF, etc., or any suitable combination of the forgoing.

The compute-readable code includes program code for animating the products mimicking the real products and program code for allowing navigation between the aisles and selection of products from the shelves by clicking-and-dragging them into the online shopping carts.

The computer-readable code includes program code for allowing each user to create multiple number of personal storerooms, and wherein the users may re-order their selected products according to their preferences in their personal storerooms that may include a daily shopping shelf, a weekend shopping shelf, a shopping for dinner event shelf, etc., and wherein the user can click-and-drag the full content of the storeroom, or each product individually to the user shopping cart.

The computer-readable code may include program code for presenting the products information on the user's electronic device screen.

The computer-readable code may include program code for removing products that were sold out and for adding new products to the public aisles shelves.

The computer-readable code may include program code for illustrating a top view of the store aisles and allowing easy navigation to a specific public aisle or to the personal storeroom using a touch screen.

The computer-readable code may include program code for providing a tool bar presented on the user's electronic device screen, wherein the tool bar comprising various option buttons.

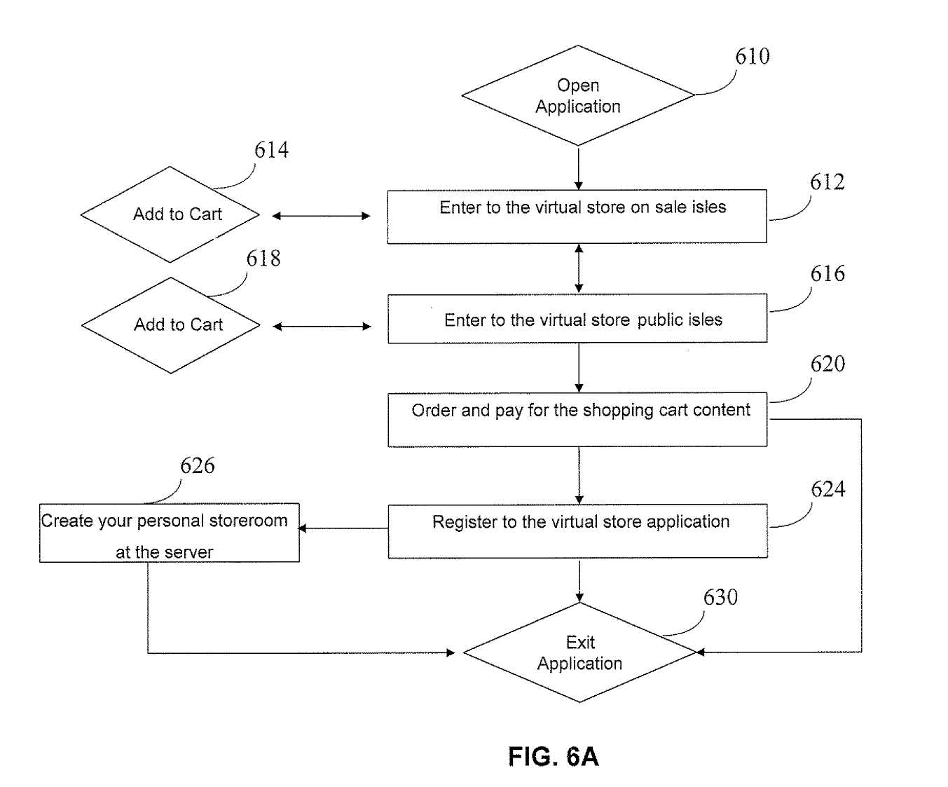

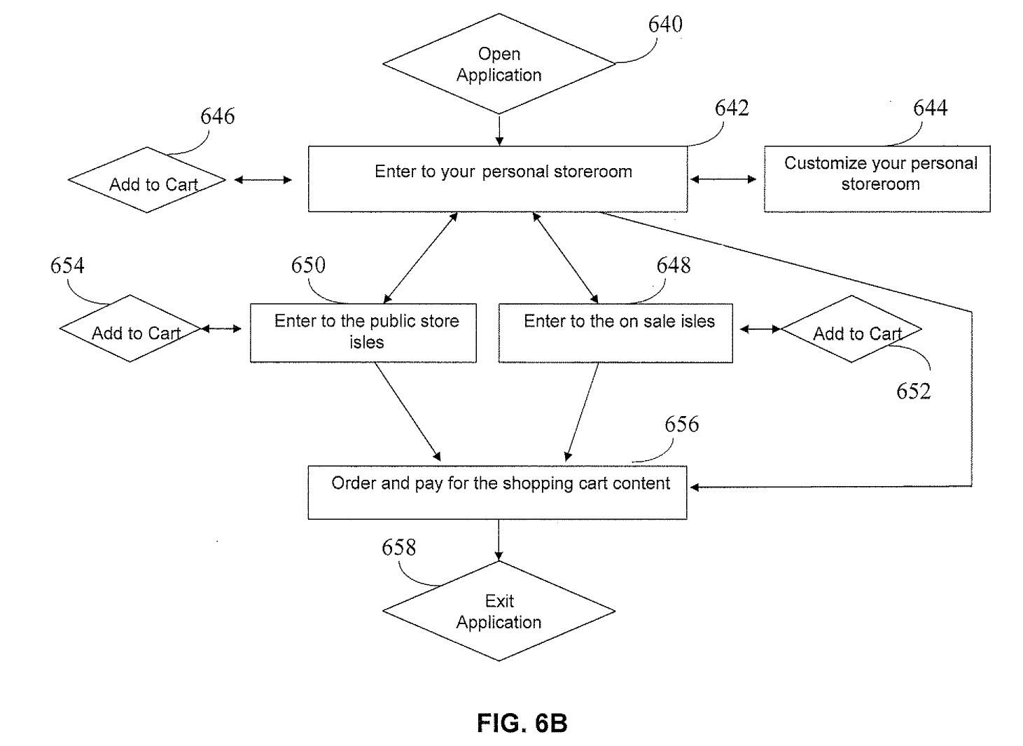

FIG. 6A illustrates the online personal store application after initialization in a flowchart diagram, according to embodiments of the present invention. The users may enter the online store application 610 using their Smartphones or the Internet. Initially, the users enter the online store an sale aisle 610. Users may select and add products to their shopping cart 612. The users may navigate through the online store public aisles 614 and select and add products to their shopping carts 616. Users may order and pay 620 for their shopping cart contents and exit the online store application 630. Alternatively, users may register to the online store application, typing in their names, address and receiving their passwords for future logins. Users may create their personal storerooms 626 by selecting a push button option. Users may exit the application 630.

FIG. 6B illustrates the online personal store application after initialization in a flowchart diagram, according to embodiments of the present invention. After the initial registration, users enter their user name and password to the online store application 640 and enter their personal storerooms 642 that include their preferred products. Users may select and add products to their shopping carts 644, order and pay for their shopping carts content 656 and exit the application 658.

According to embodiments of the present invention, the online store application stores all products purchased by a user in the user personal storeroom automatically at the server. FIG. 6B presents in a flowchart diagram the ease and convenience of the shopping experience provided by the personal storeroom of the present invention.

Advantageously, the users may customize their personal storeroom 644 according to pre-defined options provided. The users may also navigate and shop around through the on sale aisles 648 the online store public aisles 650 and select and add products to their shopping carts 652 and 654. Users may order and pay for their shopping cart contents 656 and exit the online store application 658.

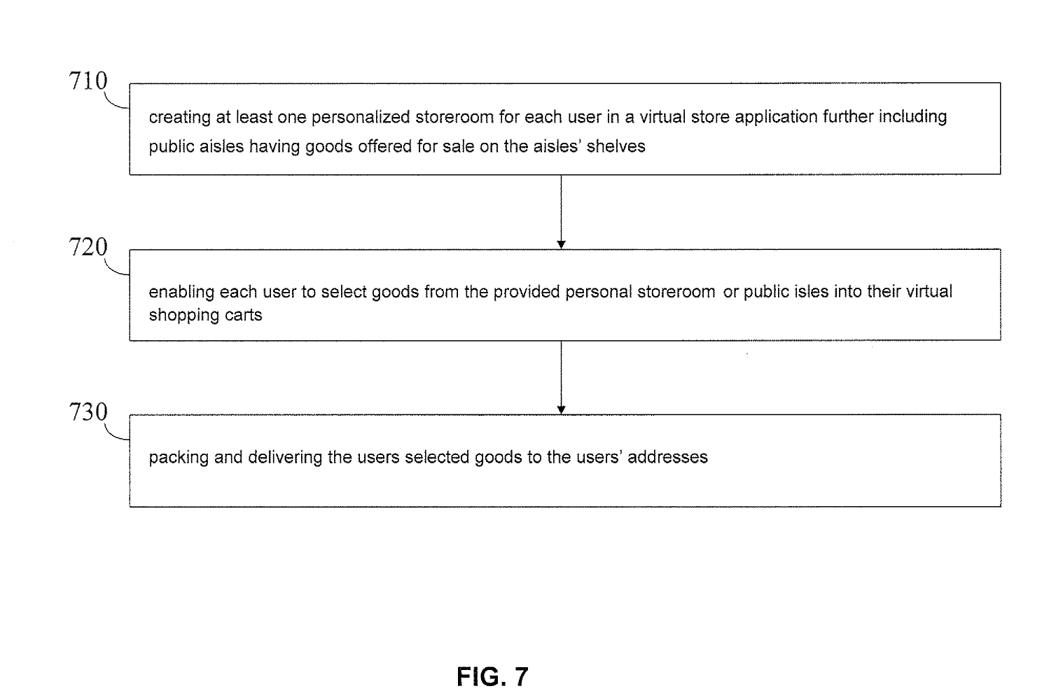

FIG. 7 illustrates the method for shopping in a personal online store in a flow chart diagram, according to embodiments of the present invention.

The provided method for shopping in an online store includes the steps of: creating at least one personal storeroom for each user in a online store application further including public aisles having products offered for sale on the aisles' shelves 710, enabling each user to select products from the provided personal storeroom or public aisles into the users' online shopping carts 720, and packing and delivering the selected products to the users 730. The method includes further the step of storing for each user the list of products that were purchased from the public aisles in the provided personal storerooms in the personal online store application memory.

The personal online store is animated as a three dimensional virtual space wherein products are presented on the aisles and are animated to mimic the real products. The personal online store application enables each user to navigate between the animated aisles and to click-and-drag products from the aisles shelves to their shopping carts. The personal online store application enables navigation between the aisles using touch screens or computer mouse.

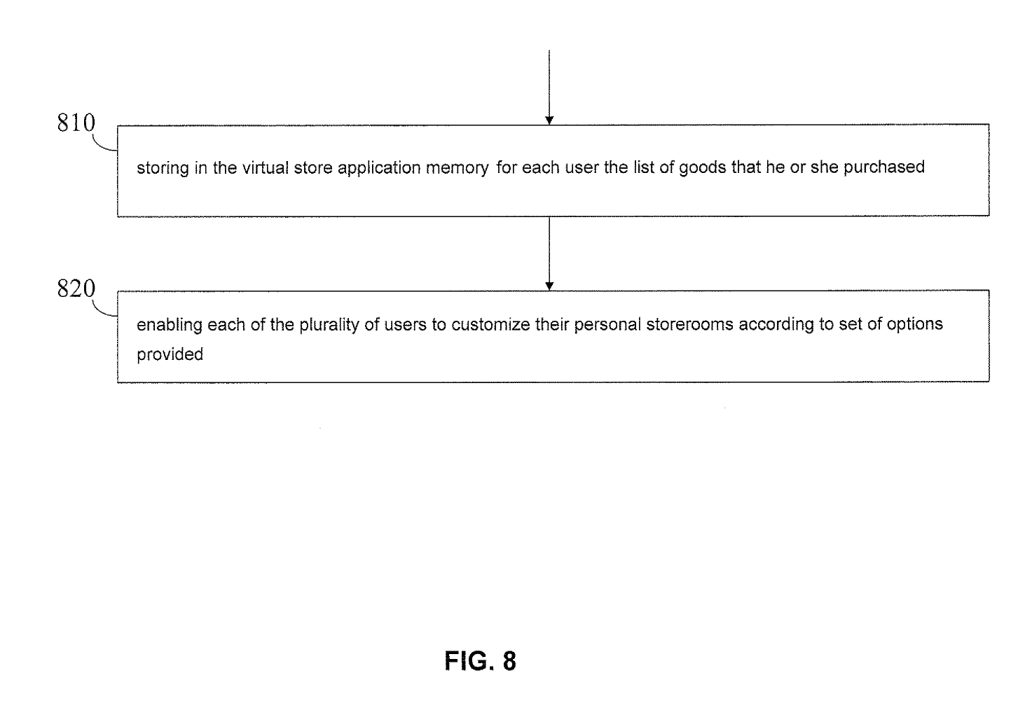

FIG. 8 is a continuation of FIG. 7 that includes further the steps of storing purchased products in the application memory and customizing the storerooms, according to embodiments of the present invention.

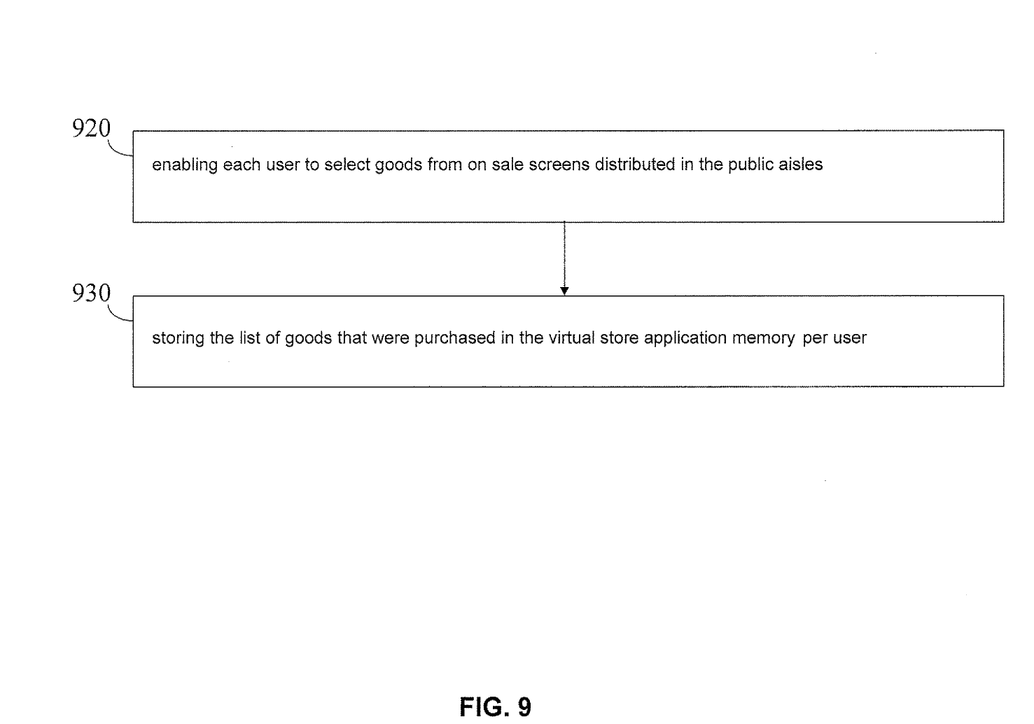

FIG. 9 is a continuation of FIG. 7 that includes further providing special offers to users on special sale screens, according to embodiments of the present invention. Animated advertisement screens are provided in the department aisles that offer products on sale to the users. The animated screens may be used to provide lists of suggested recipes, for example.

According to a further feature of embodiments of the present invention, online store employees, configured to offer products and special deals to the users when passed by, may be animated in the online store departments.

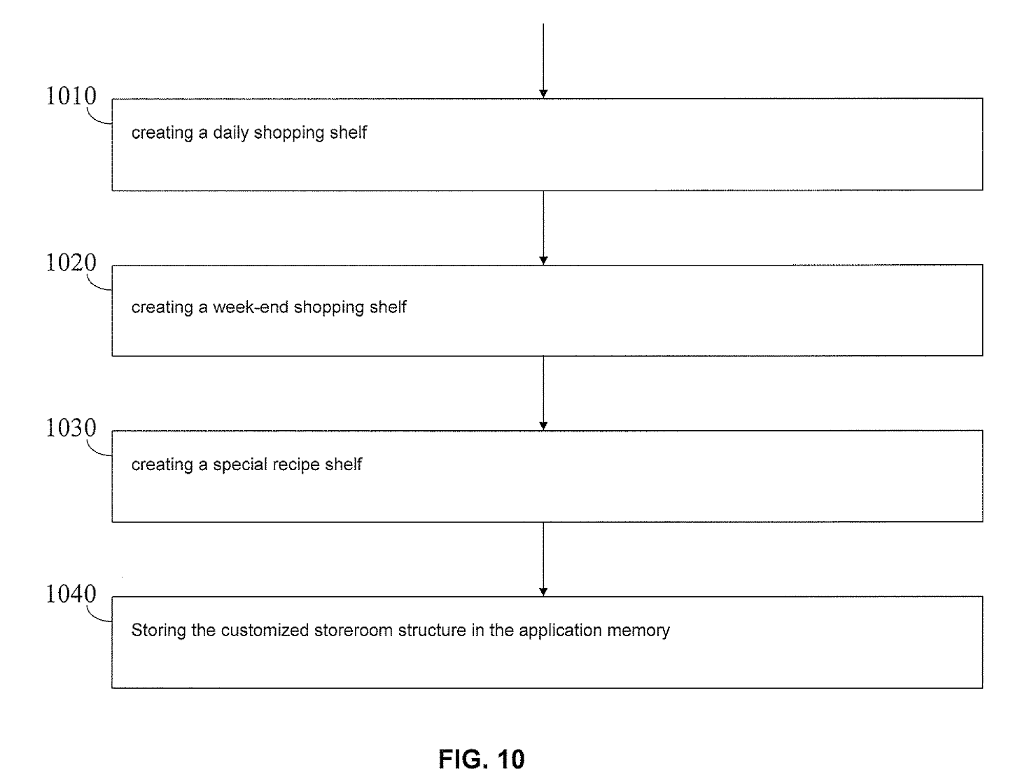

FIG. 10 is a continuation of FIG. 7 that illustrates customization of the personal storeroom in a flow chart diagram, according to embodiments of the present invention. The method may include the step of enabling each of the plurality of users to customize their personal storerooms according to set of options provided.

The set of options that may be provided includes a daily shopping shelf, a weekend shopping shelf, an event shelf. The user may conveniently select all items or each product individually from his provided personal storeroom.

According to embodiment of the present invention, a computer program product for online shopping is provided. The computer program product may include a computer readable storage medium that includes further first program instructions to create at least one personal storeroom for each user of an online store application including further public aisles offering products on their shelves. Second program instructions to enable each user to select products from the provided personal storerooms or public aisles into their virtual shopping carts may be included. The program instructions may be stored on the computer readable storage medium.

According to embodiments of the present invention, the personal online store application might be a Smartphone application, a Tablet application and the like.

According to embodiments of the present invention, the personal online store might be a supermarket, a home appliances store, a clothing store, etc.

The online store application main screen uploads typically in less than 2 seconds, a touch screen drag operation uploads typically in less than 1 second, bills and invoices are uploaded typically in less than a second.

According to embodiments of the present invention, the online store application capacity at the server may be increased according to the store requirement in real time by a service provider. The online store application allows the store owner to design the products on the shelves conveniently from an excel sheet. The online store owner may easily switch a product position from one shelf to another shelf, switch a list of products from one shelf to another, delete a complete shelf, delete a product from a shelf or add a new product to a shelf. The online store owner may enter the application editor by clicking the application icon and next he or she may deploy the changes described herein above for example online.

The online store application at the server is configured to allow advertisers to publish and perform advertisement campaigns. Advertisers are provided with audio announcements that the users hear while navigating through the online store aisles; with advertisement screens spread in between the online store aisles; store employees may be configured to offer the advertised products to users; on sale aisles may present the advertisers' products; a catalogue may be distributed to the online store users and e-mail offers may be sent to the users; a list of recommended products may be offered to the users when they touch an advertised product, etc.

The online store application at the server may provide a sale wizard that will offer sales, will summarize the shopping cart content bill and will offer additional sales accordingly. Deals such as, 1+1, Buy X and get Y, get X % discount on specific product, get multiple products with an X % discount deal, load a coupon for a given product, etc. may be provided by the sale wizard.

The online store application at the server may include an order manager module that will control and monitor the orders' status. Each order may have the following status: open order by a user, complete and saved order, paid order to be delivered, new delivery to be executed, delivery in preparation, delivery ready for distribution, delivery on the way to the user, delivery confirmed by the user, delivery returned, loss of a delivery, etc.

The order manager module may monitor in real time the delivery status, the time the delivery left the warehouse, the time the delivery arrived to destination, the real time location of the delivery vehicles, etc.

The online store application at the server may include a stock manager module that monitors the warehouses stocks and sends an alarm message to the store manager when a products is sold out or almost sold out. The stock manager may send the alarm message in advance according to users orders such that the warehouse stock may be renewed on time. The stock manager may update the stock database when renewed.

The online store at the server may include a report manager module configured to report database statuses and statistics for the store owners, the users and the advertisers.

The online store at the server may include configurable design options such as the store's colour that may be mostly white and grey for a high-tech store, wood shelves may be configured for a country style store, pink and red for a valentine store, etc.

Each product's image includes a barcode. When an image is modified in the database its image is updated automatically in the online store shelves using the product's barcode.

The online store application may allow users to chat online while navigating the online store aisles to get recommendations and tips from friends.

The online store application at the server uses hot deployment processes where users are not affected by store modifications, users that are online view the store before the modification took place and users that login to the store application after the modification took place view the modified application.

The language of the online store application may be selected from a menu of languages such as English, Spanish, French, Hebrew, Arabic etc., where the product information, option buttons, messages and advertisements are provided in the selected language.

Advantageously, online shopping in the online store is easy, effective and pleasant and is provided 24 hours a day.

The method for shopping in an online store may be beneficial to store owners since it may reduce significantly the store expenses (rent space and the number of employees needed). Furthermore, since the online store application is a fully computerized application all the products and the user operations are recorded and may be controlled and monitored easily.

The method for shopping in an online store may be beneficial to manufactures that may advertise their products conveniently through the online store application and may perform statistical analysis of the success of their advertising campaign.

Advantageously, the online personal store application provides a pleasant and effective online shopping experience.

Another advantage of the online personal store application described above is that it provides personal storerooms that may be further customized by users according to their preferences and needs.

In summary, the online personal store application of the present invention improves online shopping experience by creating a unique personal online store environment that includes only the users preferred products, allowing the users to shop efficiently.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description. While preferred embodiments of the present invention have been shown and described, it should be understood that various alternatives, substitutions, and equivalents can be used, and the present invention should only be limited by the claims and equivalents thereof.

What is claimed is:

1. A method for online shopping via wired or wireless server communication, the method comprising the steps of:
creating public aisles and at least one personal storeroom for each client in an online store application at the server; and
enabling each client to select online products offered for sale from said created personal storerooms and public aisles.

2. The method for online shopping of claim 1, further comprising presenting said online store to each said client as an animated cartoon of a three-dimensional virtual store.

3. The method for online shopping of claim 1, further comprising transmitting lists of purchased products to a warehouse and packing and delivering the selected products to the clients.

4. The method for online shopping of claim 1, wherein said step of enabling each client to select products from said provided personal storerooms or public aisles includes further the step of providing animated cartoon shopping carts to the users.

5. The method for online shopping of claim 1, further comprising the step of storing at the online store operator's server for each client the list of products that the client purchased from the public aisles in the client's personal storeroom.

6. The method for online shopping of claim 1, further comprising the step of enabling each of the plurality of clients to customize their personal storerooms.

7. The method for online shopping of claim 2, wherein said step of presenting said online store to each said client as an animated cartoon of a three-dimensional virtual store further comprising mimicking said online store products corresponding to real prodcuts.

8. The method for online shopping of claim 1, wherein said step of enabling each client to select online products from said created personal storerooms and public aisles comprising further the step of enabling the users to navigate between the online store aisles and to click-and-drag or touch-and-drag products from the shelves to the users shopping carts.

9. The method for online shopping of claim 1, wherein said online store application is selected from the group consisting of: Smartphone, Tablets and internet applications

10. The method for online shopping of claim 1, wherein said online store application mimics a store selected from the group consisting of: supermarkets, grocery stores, home appliance stores and clothing stores.

11. The method for online shopping of claim 1, wherein said step of enabling each user to select products further comprising the step of providing means for navigating between said online store aisles using touch screens or a computer mouse.

12. The method for online shopping of claim 1, comprising further the step of providing animated advertisement screens in said provided online store aisles.

13. The method for online shopping of claim 1, comprising further the step of providing animated store employees configured to offer products and on sale deals to the plurality of users.

14. The method for online shopping of claim 12, comprising further the step of providing lists of products of recommended recipes in said provided advertisements screens.

15. A system configured for online shopping, the system comprising:
a storage medium at a server for storing online store computer readable code, wherein said computer readable code includes program code for:
creating public aisles and at least one personal storeroom for each client of an online store application offering products on their shelves;
providing a virtual shopping carts to each client; and
enabling each client to select online via wired or wireless communication products from said provided personal storerooms and public aisles into said provided shopping carts; and
a processor for executing said computer readable program code.

16. The system configured for online shopping of claim 15, wherein said program code includes program code for transmitting lists of purchased products to warehouses where the products are packed and delivered to the clients.

17. The system configured for online shopping of claim 15, wherein said program code includes program code to be provided to a plurality of clients via wired or wireless communication, wherein said provided program code enable clients to use said online store application and to communicate with said online store server.

18. The system configured for online shopping of claim 15, wherein said storage medium is used to store at the server products information to be presented on said clients' electronic devices' screens.

19. The system configured for online shopping of claim 15, wherein said program code at the server is configured to allow removing products that were sold out from said warehouses and for adding new products to be offered to the users.

20. A non-transient computer-readable storage medium having computer readable code embodied on the computer-readable storage medium, the computer-readable code comprising:
program code for creating at least one personal storeroom for each user of an online store application comprising further public aisles offering products on their shelves;
program code for enabling each user to select products from said provided personal storerooms or public aisles into their virtual shopping carts;

21. The computer-readable storage medium of claim 20, wherein said computer readable code includes program code for transmitting the lists of selected products to warehouses where the products are packed and delivered to the users' addresses.

22. The computer-readable storage medium of claim 20, wherein said computer readable code includes program code for presenting said online store to each said client as an animated cartoon of a three-dimensional virtual store.

23. The computer-readable storage medium of claim 20, wherein said computer readable code includes program code for allowing navigation between said online store aisles and selection of products from the shelves by click-and-drag or touch-and-drug the products into the users shopping carts.

24. The computer-readable storage medium of claim 20, wherein said computer readable code includes program code for allowing each user to create a multiple number of personal shelves, and for enabling clients to re-order their selected products according to their preferences in said personal storerooms.

25. The computer-readable storage medium claim 20, wherein said computer readable code includes program code for selecting, individually or collectively, products from the user personal storeroom to the client shopping cart.

26. The computer-readable storage medium of claim 16, wherein said program code includes program code for removing products that were sold out from said warehouses and for adding new products to the public aisle shelves.

27. The computer-readable storage medium claim 20, wherein said computer readable code includes program code to be provided to a plurality of clients via wired or wireless communication, wherein said provided program code enable clients to use said online store application and to communicate with said online store server.

28. The computer-readable storage medium claim 27, wherein said program code provided to clients includes program code for presenting the products information on the users electronic devices' screen.

29. The computer-readable storage medium of claim 27, wherein said program code includes program code for displaying a top view of said online store aisles and allowing convenient navigation between said online store aisles.

30. The computer-readable storage medium of claim 27, wherein said program code includes program code for providing an options tool bar presented on said users electronic devices' screens

31. The computer-readable storage medium of claim 27, wherein said electronic devices are selected from the group consisting of: Smartphones, Tablets, desktop computers and mobile computers.

32. A computer program product for online shopping, the computer program product comprising:
a computer readable storage medium;
first program instructions to create at least one personal storeroom for each user of an online store application comprising further public aisles offering products on their shelves; and
second program instructions to enable each user to select products from said provided personal storerooms or public aisles into their virtual shopping carts,
wherein said program instructions are stored on said computer readable storage medium.
